(19) United States
(12) Patent Application Publication
(10) Pub. No.: US 2025/0315336 A1
(43) Pub. Date: Oct. 9, 2025

(54) SELF-DIAGNOSTIC TESTING IN A HETEROGENEOUS COMPUTING PLATFORM

(71) Applicant: Dell Products L.P., Round Rock, TX (US)

(72) Inventors: Ibrahim Sayyed, Georgetown, TX (US); Adolfo S. Montero, Pflugerville, TX (US); Alan H. Abdelhalim, Pflugerville, TX (US)

(73) Assignee: Dell Products L.P., Round Rock, TX (US)

(21) Appl. No.: 18/626,730

(22) Filed: Apr. 4, 2024

(51) Int. Cl. G06F 11/07; G06F 11/22; G06F 11/30

(52) U.S. Cl. CPC G06F 11/079; G06F 11/0751; G06F 11/2205; G06F 11/2263; G06F 11/3055

(57) ABSTRACT

Systems and methods include an Information Handling System (IHS) that is adapted to diagnose root causes of issues reported by hardware and/or software of the IHS. Telemetry is monitored that specifies operating status information for hardware components of the IHS. Stress event are detected that are related to the hardware components. One or more stress tests are identified for evaluation of each hardware component that is related to stress event. While monitoring the telemetry, the stress tests are conducted in order to replicate the detected stress event. When the detected stress event is replicated, a root cause hardware component of the IHS is determined based on machine learning evaluation of the telemetry generated during replication of the stress event.

### FIELD

This disclosure relates generally to Information Handling Systems (IHSs), and more specifically, to systems and methods for IHS diagnostics.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

In various embodiments, Information Handling Systems (IHSs) may include: one or more memory device; and one or more processors coupled to the memory devices, wherein the memory devices comprise instructions that, upon execution by the processors, cause the IHS to: monitor telemetry specifying operating status information for hardware components of the IHS; detect a stress event related to a first of the hardware components of the IHS; identity one or more stress tests for the first hardware component of the IHS; conduct the stress tests while monitoring the telemetry in order to replicate the detected stress event; and when the detected stress event is replicated, determine a root cause hardware component of the IHS based on machine learning evaluation of the telemetry generated during replication of the stress event.

In some embodiments, the instructions executed by the processors further cause the IHS to identity a second hardware component of the IHS that is related to the stress event. In some embodiments, the stress event comprises throttling events by the one or more processors due to thermal constraints, and wherein the second hardware component comprises an airflow cooling fan. In some embodiments, when the detected stress event is not replicated, the stress event is designated as spurious as an input in the machine learning evaluation used to determine the root cause hardware component. In some embodiments, the machine learning evaluation generates an output specifying a hardware component of the IHS as the root cause of the stress event. In some embodiments, the operating status information for hardware components of the IHS comprises utilization of the network controller of the IHS and wherein the stress event comprises timeout errors in attempting to communicate with the network controller. In some embodiments, the one or more stress tests comprises a stress test of the operating speeds supported by network controller of the IHS. In some embodiments, the operating status information for hardware components of the IHS comprises a status of a storage drive of the IHS and wherein the stress event comprises timeout errors in attempting to communicate with the storage drive. In some embodiments, the stress event is replicated and root cause is determined to be caused by error correction operations by the storage drive. In some embodiments, the operating status information for hardware components of the IHS comprises a network availability reported by an SoC (System-on-Chip) of the IHS and wherein the one or more stress tests comprise tests of bandwidth supported by a network controller of the IHS. In some embodiments, the network availability reported by the SoC comprises an availability of virtualized network resource provided by the network controller of the IHS. In some embodiments, the operating status information for hardware components of the IHS comprises buffering of video outputs reported by a GPU implemented by an SoC of the IHS and wherein the one or more stress test comprise loading the GPU to replicate the buffering. In some embodiments, the stress event is replicated and root cause is determined be caused by delays in response by a hard drive that is a source of data being output by the GPU. In some embodiments, the one or more stress tests are conducted upon determining the detected stress event has ended. In some embodiments, the one or more stress tests are conducted upon determining the IHS is idle. In some embodiments, the one or more stress tests are conducted by an embedded controller of the IHS while the IHS is in a low power mode.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) that is configured, according to some embodiments, to support self-diagnostic operations by the IHS.

FIG. 2 is a diagram illustrating an example of a heterogenous computing platform configured, according to some embodiments, to support self-diagnostic operations.

FIG. 3 is a diagram illustrating an example of a system, according to some embodiments, for supporting self-diagnostic operations by an IHS.

FIG. 4 is a diagram illustrating an example of a method, according to some embodiments, for supporting self-diagnostic operations by an IHS.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG's EXYNOS, APPLE's “A” SERIES, etc., which typically include ARM core(s).

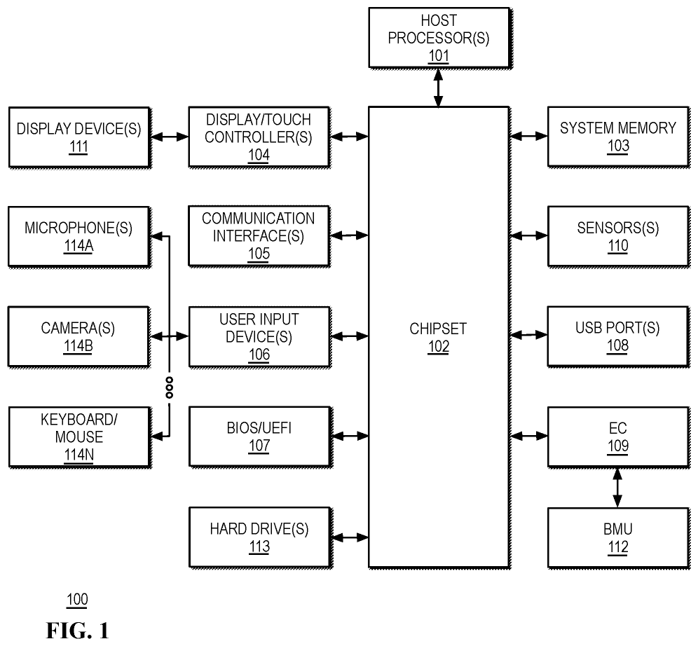

FIG. 1 is a block diagram of components of an IHS (Information Handling System) 100 that, in some embodiments, may include a heterogenous computing platform, as described in additional detail below, and that is configured to support self-diagnostic operations by the IHS, in particular to support self-diagnostic operations in which the IHS initiates stress tests in order to diagnose the root cause of detected exhaustion of hardware resources of the IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as ETHERNET, WIFI, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, headsets, etc.). Moreover, communication interface(s) 105 may be coupled to chipset 102 via a Peripheral Component Interconnect Express (PCIe) bus, or the like. Chipset 102 may be coupled to display and/or touchscreen controller(s) 104, which may include one or more or Graphics Processor Units (GPUs) on a graphics bus, such as an Accelerated Graphics Port (AGP) or PCIe bus. As shown, display controller(s) 104 provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be operate as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more USB ports 108, to which one or more peripheral devices may be coupled (e.g., integrated or external webcams, microphones, speakers, etc.). Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensor(s) 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), accelerometer, etc.

Basic Input/Output System (BIOS) 107 is coupled to chipset 102. Unified Extensible Firmware Interface (UEFI) was designed as a successor to BIOS, and many modern IHSs utilize UEFI in addition to or instead of a BIOS. Accordingly, as used herein, the term “BIOS” is intended to also encompass UEFI such that these terms may be used interchangeably. In operation, UEFI 107 provides an abstraction layer that allows the OS to interface with certain hardware components of the IHS 100. Upon booting of IHS 100, host processor(s) 101 may utilize program instructions of UEFI 107 to initialize and test hardware components that are coupled to IHS 100, and to load host OS 312 for use by IHS 100. Via the hardware abstraction layer provided by UEFI, software applications executed by host processor(s) 101 and/or SoCs 200 can interface with certain I/O devices that are coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as operating chassis buttons and/or switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing a battery charger and a battery, enabling remote management, diagnostics, and remediation over an OOB or sideband network, etc.

In some embodiments, EC 109 may implement self-diagnostic operations of an IHS. The hardware and software of an IHS 100 may generate a variety of telemetry data, where this telemetry data may characterize an operating status of a hardware component. In particular, telemetry data generated by IHS 100 may specify detected exhaustion of hardware resources of the IHS, such as detecting throttling by processor(s) 101, or the telemetry may specify operating conditions of the IHS, such as thermal measurements reported by hardware of the IHS. In some embodiment, self-diagnostic operations may be implemented by EC 109, where these self-diagnostic operations evaluate collected telemetry in order to identify events indicating the IHS is under stress, such as telemetry indicating resource exhaustion or thermal thresholds being reached. As described in additional detail below, upon identifying a stress event within the IHS telemetry, the self-diagnostic operations of EC 109 may initiate one or more stress tests seeking to reproduce the stress event. Based on telemetry collected during these stress tests by the EC 109, embodiments may identify a component or system that is the root cause, or at least a proximate cause, of the detected stress event.

Unlike other devices in IHS 100, EC 109 may be operational from IHS being powered, in particular before other devices are fully running or even powered. As such, EC 109 firmware may be responsible for interfacing with a power adapter to manage the various power states that may be supported by IHS 100. Power operations of the EC 109 may also provide other components of the IHS 100 with power status information for the IHS, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

From the perspective of users, IHS 100 may appear to be either “on” or “off,” without any other detectable power states. In some embodiments, however, an IHS 100 may support multiple power states that may correspond to the states defined in the Advanced Configuration and Power Interface (ACPI) specification, such as: S0, S1, S2, S3, S4, S5, and G3. For example, when an IHS 100 is operating in S0 working mode, the IHS is operational, but some hardware components that are not in use may still be individually configured in low power states. In an S0 low-power, idle mode (“Sleep” or “Modern Standby”), an IHS 100 remains partially running with various capabilities of the IHS (e.g., displays, network controllers) may be powered down and other capabilities (e.g., EC, processors) may be in low-power standby modes, thus supporting the ability of the IHS to quickly transition from to a full-power, working S0 mode in response to various events. In the past, S3 was commonly used as a default “Sleep state.” However, many IHSs 100 utilize the described Modern Standby, which may be designated as a hybrid “SOix” mode, where some or all of the internal hardware of IHS 100 may be placed into their lowest power state, while still supporting code execution that allows fast response and transition of the IHS to a working S0 mode.

An IHS 100 may additionally or alternatively support other low-power modes, such as S1-S3 (that may also be referred to as “Sleep” modes), where the IHS may appear to users to be in an off state. Some IHSs may support only one or two of these states, where the number of distinct states may be a reflection of power saving features of the IHS that have been selected for use. For instance, the amount of power consumed in states S1-S3 is less than S0 and more than S4. An S3 mode consumes less power than S2, and S2 consumes less power than S1. In states S1-S3, volatile memory may be periodically refreshed in order to maintain the operating state of the IHS, with some components remaining powered so that the IHS may wake based on inputs from a keyboard, Local Area Network (LAN), or a Universal Serial Bus (USB) device.

In the S4 state (“Hibernate”), power consumption is reduced to its lowest level. The IHS saves the contents of volatile memory to a hibernation file and some components remain powered, allowing the IHS to wake based on detected input from the keyboard, LAN, or a USB device. “Hybrid sleep” may implemented by some IHSs may use a hibernation file that is used to save the IHS's operating state, and also used to resume the IHSs operations upon reverting to a working S0 mode. “Fast startup” may refer to a power state where the user is logged off before the hibernation file is created, which allows for a smaller hibernation file in IHSs with reduced storage capabilities.

When in the S5 state (“Soft off” or “Full Shutdown”), an IHS 100 is fully shut down without a hibernation file. It occurs when a restart is requested or when an application invokes a shutdown command of the OS, EC 109, etc. During a full shutdown and re-boot, the user session is methodically de-constructed and restarted on the next boot. In some instances, a boot/startup from an S5 state takes significantly longer than resuming from S1-S4 states. At the hardware level, the main difference between S4 and S5 may be that S4 sets a flag on the storage device used to store the hibernation file and configures the bootloader to boot from the flagged hibernation file instead of booting the OS from scratch.

In a G3 (“Mechanical off”) power mode, the IHS 100 may be completely turned off and consumes absolutely no power from its Power Supply Unit (PSU) or main battery (e.g., a lithium-ion battery), with the exception of any Real-Time Clock (RTC) batteries (e.g., Complementary Metal Oxide Semiconductor or “CMOS” batteries, Basic Input/Output System or “BIOS” batteries, coin cell batteries, etc.), which are used to provide power for the IHS's internal clock/calendar and for maintaining certain configuration settings. In some instances, G3 represents the lowest possible power configuration of an IHS from which the IHS can be initialized. From a G3 mode, an IHS may transition to an S5 mode in response to AC power source coupling (i.e., transitioning between battery mode to AC mode). Additionally, or alternatively, an IHS may transition from G3 to S0 based upon the detection of a power button event.

EC 109 firmware may also implement operations for detecting certain changes to the physical configuration or posture of IHS 100 (such as a laptop computer), and may also manage operations of other IHS devices based on the current physical configuration of IHS 100. For instance, when IHS 100 as a 2-in-1 laptop/tablet form factor, EC 109 may receive inputs from a lid position or hinge angle sensor 110, and may use those inputs to determine: whether the two sides of IHS 100 have been latched together to a closed position or a tablet position, the magnitude of a hinge or lid angle, etc. In response to these changes, the EC 109 may enable or disable certain features of IHS 100 (e.g., front or rear facing camera, etc.).

In this manner, EC 109 may identify any number of IHS physical postures, including, but not limited to: laptop, stand, tablet, or book. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

In some implementations, EC 109 may be installed as a Trusted Execution Environment (TEE) component to the motherboard of IHS 100. Accordingly, as a component with the root of trusted hardware of IHS 100, EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate a hash value based on instructions and settings loaded for use by a hardware component of IHS 100 and may compare the calculated value against the reference hash value to determine if any modifications have been made to the component, thus indicating that the component has been compromised. As such, EC 109 may validate the integrity of hardware and software components installed in IHS 100.

In some embodiments, EC 109 may provide an OOB (Out-Of-Band) or sideband channel that allows an ITDM or Original Equipment Manufacturer (OEM) to manage various settings and configurations of an IHS 100. OOB is used in contradistinction with “in-band” communication channels that operate only after networking 105 other interfaces of the IHS have been initialized, and the OS of the IHS has been successfully booted.

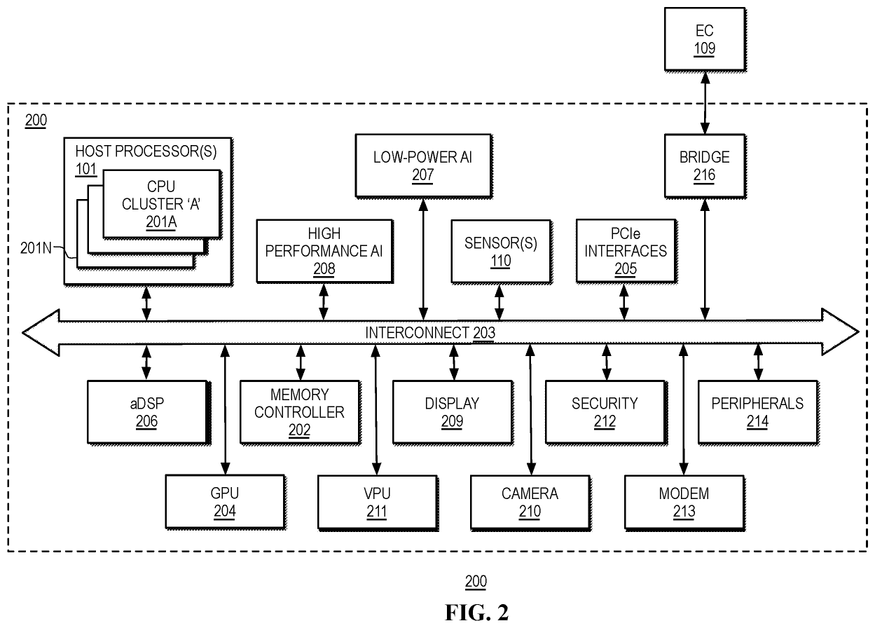

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to other IHS components, such as, for EC 109 and/or other devices within heterogeneous computing platform 200 (FIG. 2).

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), etc.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For instance, in various embodiments, host processor(s) 101 and/or other components shown in FIG. 1 (e.g., chipset 102, display controller(s) 104, communication interface(s) 105, EC 109, etc.) may be replaced by devices within heterogenous computing platform 200 (FIG. 2). As such, IHS 100 may assume different form factors including, but not limited to: servers, workstations, desktops, laptops, appliances, video game consoles, tablets, smartphones, etc.

Historically, IHSs with desktop and laptop form factors have had conventional host OSs executed on INTEL or AMD's “x86”-type processors. Other types of processors, such as ARM processors, have been used in smartphones and tablet devices, which typically run thinner, simpler, and/or mobile OSs (e.g., ANDROID, IOS, WINDOWS MOBILE, etc.). More recently, however, IHS manufacturers have started producing fully-fledged desktop and laptop IHSs equipped with ARM-based, heterogeneous computing platforms. Accordingly, host OSs (e.g., WINDOWS on ARM) have been developed to provide users with a familiar OS experience on those platforms.

FIG. 2 is a diagram illustrating an example of heterogenous computing platform 200 configured to support self-diagnostic operations, in particular self-diagnostic operations where the heterogenous computing platform operates in detecting stress events related to IHS hardware. In some embodiments, the self-diagnostic operations may provide root cause information for stress events impacting the operation of the heterogenous computing platform 200, but the platform 200 is unable to diagnose the cause of these stress events directly due to virtualization of the actual IHS hardware. In some embodiments, the self-diagnostic operations provide root cause information for stress events detected by the heterogenous computing platform 200, but that have a root cause in an IHS component or system that does not include the heterogenous computing platform 200.

In various embodiments, heterogenous computing platform 200 may be implemented in one or more SoCs, FPGAs, ASICs, or the like. Heterogenous computing platform 200 may include one or more discrete and/or segregated devices or components, each having a different set of processing capabilities suitable for handling a particular type of computational task. When each device in platform 200 is tasked with executing only the types of computational tasks that it is specifically designed to execute, the overall power consumption of heterogenous computing platform 200 is minimized.

In various implementations, some of the devices in heterogenous computing platform 200 may include their own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device in heterogenous computing platform 200 may be accessible through a respective Application Programming Interface (API). Additionally, or alternatively, some devices in heterogenous computing platform 200 may execute their own OS. Additionally, or alternatively, one or more of the devices of heterogenous computing platform 200 may be virtual devices and may thus operate virtual machines.

As described in additional detail below, operating systems that run on the heterogenous computing platform 200 may include one more service OSs 316. In some embodiments, service OSs 316 operating on heterogenous computing platform 200 may have access to IHS hardware and may thus have use of diagnostic operations that are supported by the IHS. However, in some instances, service OSs 316 may operate using virtualized hardware, such as a process of a virtual machine operated by the heterogenous computing platform 200. In such instances, diagnostic operations of the IHS 100 may be of limited use to service OSs, or to any other applications operating on the heterogenous computing platform 200 that rely on virtualized hardware. As described in additional detail below, embodiments provide self-diagnostic IHS hardware operations in scenarios where stress events are reported by a heterogenous computing platform 200 or other system utilizing virtualized hardware.

In some embodiments, heterogenous computing platform 200 includes CPU clusters 201A-N that may correspond to system processor(s) 101, and that are intended to perform general-purpose computing operations. Each of CPU clusters 201A-N may include one or more processing cores and cache memories. In operation, CPU clusters 201A-N are available and accessible to the IHS's host OS 312 (e.g., WINDOWS on ARM) and other applications executed by IHS 100.

CPU clusters 201A-N may be coupled to memory controller 202 via internal interconnect fabric 203. Memory controller 202 may be responsible for managing system memory access for all of devices connected to internal interconnect fabric 203, which may include any communication bus suitable for inter-device communications within an SoC (e.g., Advanced Microcontroller Bus Architecture or “AMBA,” QuickPath Interconnect or “QPI,” HyperTransport or “HT,” etc.). All devices coupled to internal interconnect fabric 203 may communicate with each other and with a host OS executed by CPU clusters 201A-N. In some cases, devices 209-211 may be coupled to internal interconnect fabric 203 via a secondary interconnect fabric (not shown). A secondary interconnect fabric may include any bus suitable for inter-device and/or inter-bus communications within an SoC.

A GPU 204 of the heterogenous computing platform 200 produces graphical or visual content and communicates that content to a monitor or display of the IHS 100 for rendering. In some embodiments, display engine 209 may be designed to perform additional video enhancement operations. In operation, display engine 209 may implement procedures for provide the output of GPU 204 as a video signal to one or more external displays coupled to IHS 100 (e.g., display device(s) 111). PCIe interfaces 205 provide an entry point into any additional devices external to heterogenous computing platform 200 that have a respective PCIe interface (e.g., graphics cards, USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc. In operation, input and/or output audio streams may pass through and be processed by aDSP 206, which can send the processed audio to other devices on internal interconnect fabric 203 (e.g., CPU clusters 201A-N). In some embodiments, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.).

Camera device 210 includes an Image Signal Processor (ISP) configured to receive and process video frames captured by a camera coupled to heterogenous computing platform 200 (e.g., in the visible and/or infrared spectrum). Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Sensor hub 207 may include AI capabilities designed to consolidate information received from other devices in heterogenous computing platform 200, process context and/or telemetry data streams, and provide that information to: (i) a host OS, (ii) other applications, and/or (iii) other devices in platform 200. In collecting data, sensor hub 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.). Sensor hub 207 may include a low-power core configured to execute small neural networks and specific applications, such as contextual awareness and other enhancements.

High-performance AI device 208 is a significantly more powerful processing device than sensor hub 207, and it may be designed to execute multiple complex AI algorithms and models concurrently (e.g., Natural Language Processing, speech recognition, speech-to-text transcription, video processing, gesture recognition, user engagement determinations, etc.). For example, high-performance AI device 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks. Using such capabilities, one or more devices of heterogeneous computing platform 200 (e.g., GPU 204, aDSP 206, sensor hub 207, high-performance AI device 208, VPU 211, etc.) may be configured to execute one or more AI model(s), simulation(s), and/or inference(s).

Security device 212 may include one or more specialized security components, such as a dedicated security processor, a Trusted Platform Module (TPM), a TRUSTZONE device, a PLUTON processor, or the like. In various implementations, security device 212 may be used to perform cryptography operations (e.g., generation of key pairs, validation of digital certificates, etc.) and/or it may serve as a hardware root-of-trust (RoT) for heterogenous computing platform 200 and/or IHS 100.

Modem/wireless controller 213 may be designed to enable wired and wireless communications in any suitable frequency band (e.g., BLUETOOTH or “BT,” WiFi, CDMA, 5G, satellite, etc.), subject to AI-powered optimizations/customizations for improved speeds, reliability, and/or coverage. Peripherals 214 may include any device coupled to heterogenous computing platform 200 (e.g., sensors 110) through mechanisms other than PCIe interfaces 205. In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100, where configuration of such hardware may be via modifications to UEFI variables corresponding to a respective hardware component.

In some implementations, EC 109 may be integrated into heterogenous computing platform 200 of IHS 100. In other implementations EC 109 may be external to the heterogenous computing platform 200 (i.e., the EC 109 residing in its own semiconductor package) but coupled to integrated bridge 216 via an interface (e.g., enhanced SPI or “eSPI”), thus supporting the EC's ability to access the SoC's internal interconnect fabric 203, including sensor hub 207 and sensor(s) 110. Through this connectivity supported by the interconnect fabric 203, EC 109 may directly access and/or operate most or all of devices 201-216, 110 of the heterogenous computing platform 200.

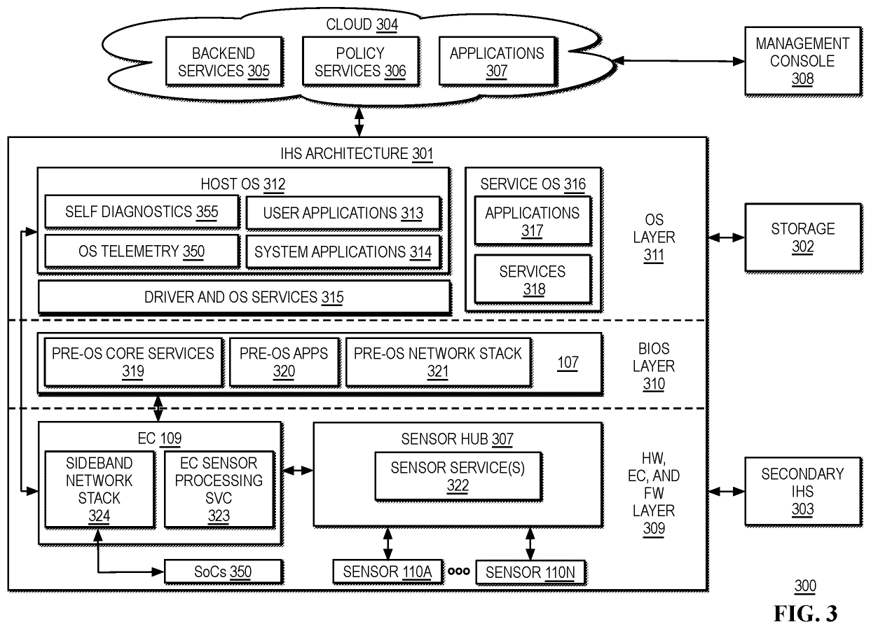

FIG. 3 is a diagram illustrating an example of architecture 300 for supporting self-diagnostic operations by an IHS. Embodiments provide such self-diagnostic operations in scenarios where applications operated by the heterogenous computing platform 200, such as a service OS 316, may operate using hardware of IHS 100, but may do so in a virtualized manner that limits the ability of the service OS 316 to operate available IHS hardware diagnostics in response to detecting resource exhaustion or another stress event related to IHS hardware. In additional, the use of virtualized hardware significantly limits the ability of the service OS 316, or any other applications of the heterogenous computing platform 200 to identify a possible root cause of an identified stress event related to IHS hardware. As described in additional detail below, embodiments support self-diagnostic operations for identifying hardware of the IHS that is a possible root cause of a detected hardware stress event, whether the stress event is detected by a service OS 316, the host OS 312, or by any other application operating on the IHS.

As illustrated, architecture 300 includes IHS 301 (e.g., implementing aspects of IHS 100 and/or platform 200) coupled to storage device 302 (e.g., NVMe, SSD, etc.), secondary or companion IHS 303 (e.g., a smart phone, a laptop, etc.), and cloud or remote services 304. Cloud 304 may include backend or remote services 305, policy services 306, and web applications 307. In some cases, components of cloud 304 may be accessible to IHS 301 and/or secondary IHS 303, and configurable via ITDM management console 308. IHS architecture 301 may include hardware/EC/firmware layer 309, UEFI layer 107, and OS layer 311.

OS layer 311 includes a host OS (Operating System) 312 that is executed by host processor(s) 101. A variety of software applications may operate within the OS 312, where these applications may include user applications 313 and system applications 314, one or more OS telemetry applications 350. OS layer 311 may also include various drivers and other core OS operations, such as the operation of a kernel. In some embodiments, booting of the host OS 312 is selected based on selection of a boot device that includes the host OS boot code during the boot sequence of the IHS 100. In many instances, this boot device that includes instructions for booting the host OS 312 is the default boot device of the IHS 100. In some embodiment, the telemetry 350 supported by host OS 312 may be utilized in identifying stress events, such as resource exhaustion and/or elevated thermal readings, reported by hardware of the IHS. In providing self-diagnostic capabilities for identifying a possible root cause of a stress event, embodiments may utilize this OS telemetry 350 and a variety of other telemetry generated by components of the IHS, such as telemetry collected directly from affected hardware.

As described, various components of a heterogenous computing platform may independently run their own operating systems, such as a service OS 316 that is run by an SoC 200 that is used to implement the heterogenous computing platform. Within IHS architecture 301, some of these discrete operating systems operated by the heterogenous computing platform 200 may be considered service OSs 316, where each service OS may each include its own applications 317 and services 318. In some embodiments, each service OS 316 may additionally generate telemetry for use in identifying hardware stress events experienced by service OS 316 and/or by the SoC 200 used to implement the heterogenous computing platform 200. In some instances, stress events detected by a service OS 316 may be due to issues caused by the service OS itself, such as a non-responsive process of the service OS that will not release memory resources, or may instead be caused by the SoC 200 on which the service OS 316 runs, or may instead by caused by issues with other hardware of the IHS, such as errors by an IHS network controller 105 relied on by the SoC. Accordingly, embodiments provide self-diagnostic IHS operations that identify the root cause of such IHS hardware issues that may have cascading effects that cause difficulty in isolating a root cause.

UEFI layer 107 may include UEFI core services 319, UEFI NVRAM 320, and UEFI network stack 321. UEFI core services 319 may include operations for identifying and validating the detected hardware components of an IHS. Portions of NVRAM 320 may be utilized to store core UEFI instructions and to store variables that are used to set UEFI boot and runtime variables that may be used to configure settings of individual hardware components of an IHS 100, such as configurable firmware operations of hardware components.

The UEFI network stack 321 may be utilized during initialization of the IHS in support of validation procedures, such as in retrieving reference signatures corresponding to authentic firmware instructions for hardware components of an IHS 100. UEFI core service 319 may also include operations for interfacing with certain hardware of an IHS, in particular user I/O hardware devices 350. As described in additional detail below, UEFI core services 319 may also include instructions for booting IHS 100.

As illustrated, IHS architecture 301 also includes a hardware/EC/firmware layer 309 that includes EC 109 and sensor hub 207. As described above, EC 109 may implement a variety of procedures for management of individual hardware of an IHS 100 and of the IHS itself, including management of the various power states that are supported by the IHS. EC 109 is configured to execute one or more sensor services that interface with sensor hub 207 in implementing various features of an IHS 100, such as response to user-presence determination by the sensor hub 207 that is acted upon by the EC 109 in initiation heightened security protocols. As described, EC 109 may interface with some or all of the individual hardware components/systems of an IHS via sideband management channels that are separate from inline communication channels used by the host processor 101 and SoCs.

As indicated in FIG. 3, EC 109 may support one or more self-diagnostic modes 323, in particular self-diagnostic modes by which EC may run diagnostic tests seeking to identify the cause of a detected stress events related to IHS hardware. In some embodiments, the self-diagnostic mode 323 supported by the EC 109 may be a validated firmware environment for diagnostic stress testing of IHS hardware, where such stress testing is directed at identify a root cause hardware component of a detected stress event. As described, a heterogenous computing platform 200 and IHS 100 may rely on a wide variety of over-lapping capabilities, thus increasing the difficulty in identifying root causes of stress events that span multiple operating domains of the IHS.

Also as indicated in FIG. 3, host OS 312 may also support one or more self-diagnostic modes 355, in particular self-diagnostics by which host OS applications may run diagnostic tests seeking to identify the cause of a detected stress events related to IHS hardware. As with the EC 109 diagnostics, the OS self-diagnostics 355 may provide diagnostic stress testing of IHS hardware, where such stress testing is directed at identify a root cause hardware component of a detected stress event. As described in additional detail below, in some embodiments, use of EC self-diagnostics 323 may be limited to offline diagnostics and OS self-diagnostics 355 may be utilized in providing diagnostics that operate while the OS is running.

In providing remote management capabilities of an IHS 100 and of individual hardware components on the IHS, EC 109 may operate one or more sideband management signaling pathways. As described above, EC 109 may operate from a separate power plane from the main system resources of an IHS, such as processors 101 and heterogenous computing platform 200. Accordingly, EC 109 may implement self-diagnostic operations that may run when other hardware is idle, with no applications other than the self-diagnostic operations of the EC operating on IHS 100. Through such self-diagnostic operating modes, EC 109 diagnostic modes 323 may apply a series of stress tests on hardware of the IHS, as described in additional detail below, in order to replicate and identify reported the root cause hardware system of stress events, such as resource exhaustion and thermal thresholds being reached.

Whereas EC self-diagnostics 323 may operate when all other hardware of the IHS is idle, OS self-diagnostics 355 may be used during normal operations of the IHS. As described in additional detail below, machine learning models may be utilized in identifying a hardware system as the root cause of a detected stress event, where telemetry related to the detected stress events may be used as inputs to neural networks that are trained to identify root cause systems of stress events in the telemetry. In some instances, the training of such neural networks and their abilities in pattern identification may benefit from telemetry collected during a wider variety of operating conditions. As such, OS self-diagnostics 355 may operate during normal IHS operations in attempting to replicate and diagnose certain stress events. In some embodiments, EC self-diagnostics 323 may be configured to limit initial diagnostic stress tests to idle intervals and to initiate OS self-diagnostic 355 stress tests during normal operating conditions only after initial diagnostics have not identified the root cause and the stress events continues to be reported in the collected telemetry.

As described above, sensor hub 207 may receive inputs from some or all of the sensors 110A-N of an IHS 100. Sensor hub 207 may implement a variety of sensor service(s) 322 for communicating with and collecting data from sensors 110A-N. In some embodiments, sensor hub 207 may implement shock detection procedures that may incorporate inputs from inertial and other sensors 110A-N of an IHS. Such shock detection procedures may detect shocks experienced by an IHS 110 and may characterize and assess detected shocks in evaluating possible damage to the IHS.

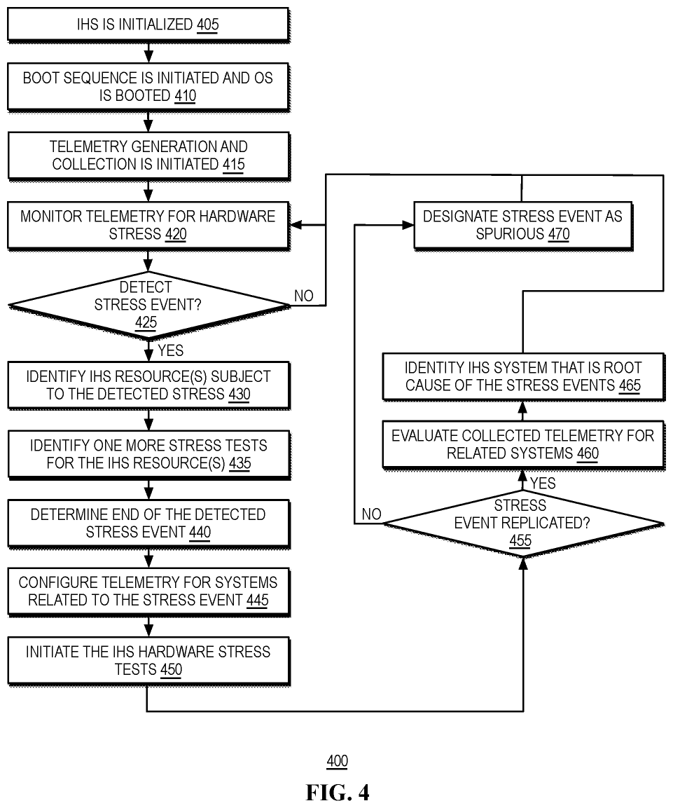

FIG. 4 is a diagram illustrating an example of a method, according to some embodiments, for supporting self-diagnostic operations by an IHS. Embodiments may begin, at 405, with the initialization of an IHS 100 that includes a heterogenous computing platform 200. Upon being powered, at 410, secured boot instructions are accessed in order to initialize a host processor 101 and to locate instructions, in some embodiments stored in UEFI NVRAM 320, for initiating a UEFI boot sequence. The UEFI boot sequence may be described as a series of phases, where successful completion of one phase is generally required for the operation of subsequent phases of the boot sequence. The boot sequence ends with the retrieval of boot code corresponding to the host OS 312 and the use of these instructions to boot an OS.

With one or more OSs 312,316 booted, at 415, embodiments initiate the generation and collection of telemetry that indicate hardware resource stress events. In some embodiments, desired telemetry may be configured through subscription APIs supported by hardware components or other IHS systems that generation and/or distribute telemetry. The telemetry that may be collected includes any telemetry providing an indication of stress on a hardware component of the IHS 100. For instance, the collected telemetry may identity stress events related to processors(s), such as reports of throttling by a processor and reports of CPU thermal thresholds being triggered. In some instances, the collected telemetry may identify stress events related to an SoC used to implement a heterogenous computing platform 200, such as reports of resource exhaustion reported by the SoC or by specific functions implemented by the SoC. In some instances, the collected telemetry may identity stress events related to available capacity of system memory 103, such as low memory events resulting in a non-responsive IHS. In some instances, the collected telemetry may identity stress events related to use of a specific resources, such as timeout errors reported by components attempting to issue queries to hard drive 113 or bandwidth limitations reported in attempting to utilize a network controller 105.

Once telemetry generation has been configured, at 420, embodiments may monitor for hardware stress events within the collected telemetry. As described above, various hardware resource and a variety stress events may be monitored for each hardware component of the IHS. At 425, embodiments detect a stress event in the collected telemetry. The stress event may be detected directly in telemetry generate by a hardware component, such as detecting telemetry indicating throttling by a CPU 101. The stress event may instead by detected indirectly, such as telemetry from SoC 200 of buffering in the video outputs being generated by GPU 204. Upon detecting a stress event, at 430, embodiments identity one or more hardware components of the IHS that are related to the stress event.

In some embodiments, the hardware component generating telemetry may be specified in telemetry metadata. In some instances, the stress event relates to a single hardware component, such as a stress event related to use of a hard drive 113. In some instances, the stress event relates to multiple hardware component, such as a stress event indicating throttling by processors 101 due to high temperatures, thus involving the airflow cooling system. In another illustrative example, the stress event of output buffering by GPU 204 may relate to the ability to retrieve video data from hard drive 113 of the IHS.

For each of the hardware components determined to be related to the stress event, 435, one or more stress tests are identified. For instance, in response to a CPU throttling stress event, embodiments may identify a stress test that loads the processors(s) of the IHS 100. Similarly, a hard driver 113, system memory 103 and network controller 105 may be stressed tested using diagnostic tools that load these system with request and monitor for replication of the detected stress event. Stress tests for an SoC used to implement a heterogenous computing platform 200 may be selected based on the type of IHS resource exhaustion detected in the stress event. For instance, an SoC used to implement a heterogenous computing platform 200 may generate error telemetry reporting network connectivity failures such that the network controller 105 of the IHS 100 may be a possible root cause. In such instances, embodiments may identify the SoC and the network controller of the IHS as related to the connectively stress event and may designate separate network stress tests for both the SoC and the network controller. In some instances, related components may be known, in other instances, related components may be identified through the use of machine learning tools that are used in evaluating the telemetry collected during the stress tests. In this manner, one or more stress tests related to the detected stress event may be identified.

Some embodiments may delay initiating these stress tests until, at 440, the detected stress event has subsided, and in some instances until the IHS is idle. In some embodiments, EC self-diagnostics 323 may provide diagnostic stress tests for operation when the IHS is idle, including during low power modes of the IHS when the processors 101 are not operating. Conversely, OS self-diagnostics 355 may provide diagnostic stress tests for operation while the OS of the IHS is running, thus providing stress testing in real world operating conditions. Accordingly, embodiments may schedule certain diagnostic stress tests to be conducted by one or both of the EC self-diagnostics 323 and the OS self-diagnostics 355 when the IHS is idle, such as during a modern standby interval. Some embodiments may initiate OS self-diagnostics 355 immediately upon detecting suitable operating conditions that will support the stress tests.

In some embodiments, the scheduled stress tests may be initiated as soon as the end of the stress event has been confirmed, such as system memory utilization dropping below a threshold level. As described, such stress event trials may be utilized in order to expand the training provided to machine learning tools being used to identify a root cause hardware component for a detected stress event. In some embodiments, the scheduled stress tests may be delayed until the stress event has subsided and the IHS is confirmed to be in an idle state. In some embodiments, the schedule stress tests may be delayed until the IHS 100 is in a low power mode. As described above, embodiments may be implemented at least in part by EC 109 that operates from a separate power plane from processors 100 and SoCs and may perform diagnostic operations during various low-power operating modes, and utilizing sideband signaling pathways, while also utilizing OS self-diagnostic 355 that provide additional diagnostic testing during real world conditions.

Once the stress event has ended and the IHS is otherwise deemed ready for stress testing, at 445, the generation and collection of additional telemetry is configured for each of the hardware components determined to be related to the stress event. In some embodiments, stress tests may be repeated using different related hardware components in order to expand the scope of stress test data provided to the machine learning algorithms. Embodiments may specify the telemetry to be collected and the frequency at which the telemetry is to be collected and reported for the duration of the stress tests. With the telemetry configured, at 450, embodiments initiate the scheduled stress tests on the hardware components that are related to the stress event. In scenarios where multiple hardware components are related to the stress test, each may be separately stress tested and they may additionally be tested in combination with each other through multiple iterations of these self-diagnostic procedures. All such variations may provide useful training data to the machine learning algorithms.

While each stress tests is underway, embodiments monitor the requested telemetry that is being generated. Once a stress test has concluded, any number of additional stress tests may be conducted. A single hardware component may be individually subject to multiple stress tests. For instance, in a scenario where the stress event indicates limited network bandwidth availability by an SoC used to implement a heterogenous computing platform 200, embodiments may specify a battery of diagnostics tests to be performed on the network controller of the IHS. One battery of tests may fully saturate every port of the network controller with network requests using TCP/IP requests and another battery of tests that fully saturates ever port of the network controller with PHY layer network traffic requests. Through such test, self-diagnostics may isolate a stress event as a hardware-related network controller issue that is impeding physical layer communications, and thus identifying a root cause to network timeout issues reported by an SoC 200 or of a hardware function of the SoC, such as GPU 204.

For each stress test that is conducted, at 455, embodiments determine whether the detected stress event has been replicated. In scenarios where the stress event is not replicated in any of the stress tests that are conducted, embodiments may infer that the stress event is a spurious event that is not immediately reproduceable and may thus be a result of an occasional spike in activity that is common during operation of an IHS 100. In some embodiments, at 470, a detected event that was not replicated through any of the applied stress tests may be designated as a spurious event in feedback training of a machine learning model, such as a machine learning model operated by heterogenous computing platform 200, such as in low power AI module 207.

As described above, one or more machine learning models may be generated and trained for use in the self-diagnostic evaluation of telemetry data that is collected, where the models may be used to identity the root cause of a hardware stress event. For instance, a neural network may be configured to received streams of telemetry collected during a stress test as inputs and to generate an output that identifies a hardware component that is deemed the root cause of the stress event, where the root cause determination is made based on replication of the detected hardware stress event during the stress tests. Accordingly, such designations of spurious events generated in embodiments may be provided as feedback inputs to such neural network machine learning algorithms in order to improve the predication abilities of the algorithm in correlating patterns in telemetry data to repeatable stress events, and in identifying the hardware issue that is the root cause of the stress event.

In scenarios where the detected stress event is replicated by one or the stress tests, at 460, embodiments evaluate all of the collected telemetry for each of the hardware components that are related to the detected stress event, such as via the described neural network. At 465, embodiments evaluate the stress test data in order to identify a hardware component as the root cause of the stress event, where the root cause determination is supported by a specific condition or event that has been identified in the stress test telemetry as a basis for the root cause determination. In some embodiments, the described machine learning tools may be configured to generate an output that identifies a hardware component that is the root cause of the stress event that has been successfully reproduced and to identify telemetry that identifies this hardware component as the root cause.

For instance, in a scenario where error messages generated by an SoC 200 has been detected in the collected telemetry where the SoC is reporting timeout errors in response to write and read requests issued to a Flash storage device of the IHS, embodiments may initiate stress testing of the Flash storage device. As described, additional Flash storage telemetry may be enabled during the stress testing. Based on the telemetry collected during the stress testing, the machine learning model identifies a large percentage of Flash transactions requiring single bit error correction, which may be conducted transparently by the Flash driver, but impacts operating speed of device, thus resulting in timeout errors during heavy loads. Based on root cause information identified through operation of embodiments, Flash settings may be modified to prolong its remaining lifespan.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
one or more memory device; and
one or more processors coupled to the memory devices, wherein the memory devices comprise instructions that, upon execution by the processors, cause the IHS to:
monitor telemetry specifying operating status information for hardware components of the IHS;
detect a stress event related to a first of the hardware components of the IHS;
identity one or more stress tests for the first hardware component of the IHS;
conduct the stress tests while monitoring the telemetry in order to replicate the detected stress event; and
when the detected stress event is replicated, determine a root cause hardware component of the IHS based on machine learning evaluation of the telemetry generated during replication of the stress event.

2. The IHS of claim 1, wherein the instructions executed by the processors further cause the IHS to identity a second hardware component of the IHS that is related to the stress event.

3. The IHS of claim 2, wherein the stress event comprises throttling events by the one or more processors due to thermal constraints, and wherein the second hardware component comprises an airflow cooling fan.

4. The IHS of claim 1, wherein, when the detected stress event is not replicated, the stress event is designated as spurious as an input in the machine learning evaluation used to determine the root cause hardware component.

5. The IHS of claim 1, wherein the machine learning evaluation generates an output specifying a hardware component of the IHS as the root cause of the stress event.

6. The IHS of claim 1, wherein the operating status information for hardware components of the IHS comprises utilization of the network controller of the IHS and wherein the stress event comprises timeout errors in attempting to communicate with the network controller.

7. The IHS of claim 6, wherein the one or more stress tests comprises a stress test of the operating speeds supported by network controller of the IHS.

8. The IHS of claim 1, wherein the operating status information for hardware components of the IHS comprises a status of a storage drive of the IHS and wherein the stress event comprises timeout errors in attempting to communicate with the storage drive.

9. The IHS of claim 8, wherein the stress event is replicated and root cause is determined to be caused by error correction operations by the storage drive.

10. The IHS of claim 1, wherein the operating status information for hardware components of the IHS comprises a network availability reported by an SoC (System-on-Chip) of the IHS and wherein the one or more stress tests comprise tests of bandwidth supported by a network controller of the IHS.

11. The IHS of claim 10, wherein the network availability reported by the SoC comprises an availability of virtualized network resource provided by the network controller of the IHS.

12. The IHS of claim 1, wherein the operating status information for hardware components of the IHS comprises buffering of video outputs reported by a GPU implemented by an SoC of the IHS and wherein the one or more stress test comprise loading the GPU to replicate the buffering.

13. The IHS of claim 12, wherein the stress event is replicated and root cause is determined be caused by delays in response by a hard drive that is a source of data being output by the GPU.

14. The IHS of claim 1, wherein the one or more stress tests are conducted upon determining the detected stress event has ended.

15. The IHS of claim 14, wherein the one or more stress tests are conducted upon determining the IHS is idle.

16. The IHS of claim 1, wherein the one or more stress tests are conducted by an embedded controller of the IHS while the IHS is in a low power mode.

17. A method for booting an Information Handling System (IHS), the method comprising:
monitoring telemetry specifying operating status information for hardware components of the IHS;
detecting a stress event related to a first of the hardware components of the IHS;
identifying one or more stress tests for the first hardware component of the IHS;
conducting the stress tests while monitoring the telemetry in order to replicate the detected stress event; and
when the detected stress event is replicated, determining a root cause hardware component of the IHS based on machine learning evaluation of the telemetry generated during replication of the stress event.

18. The method of claim 11, wherein the one or more stress tests are conducted upon determining the detected stress event has ended.

19. The method of claim 11, wherein the one or more stress tests are conducted upon determining the IHS is idle.

20. An storage device having instructions stored thereon, wherein execution of the instructions by one or more processors of an IHS (Information Handling System) causes the processor to:
monitor telemetry specifying operating status information for hardware components of the IHS;
detect a stress event related to a first of the hardware components of the IHS;
identity one or more stress tests for the first hardware component of the IHS;
conduct the stress tests while monitoring the telemetry in order to replicate the detected stress event; and
when the detected stress event is replicated, determine a root cause hardware component of the IHS based on machine learning evaluation of the telemetry generated during replication of the stress event.
